(19) United States
(12) Patent Application Publication
(10) Pub. No.: US 2010/0186074 A1
(43) Pub. Date: Jul. 22, 2010

(54) Authentication Using Graphical Passwords

(76) Inventors: Angelos Stavrou, Springfield, VA (US); Alireza P. Sabzevar, Falls Church, VA (US)

Correspondence Address: GEORGE MASON UNIVERSITY;OFFICE OF TECHNOLOGY TRANSFER, MSN 5G5, 4400 UNIVERSITY DRIVE, FAIRFAX, VA, 22030, US

(21) Appl. No.: 12/688,037

(22) Filed: Jan. 15, 2010

Related U.S. Application Data
(60) Provisional application No. 61/145,230, filed on Jan. 16, 2009.

(51) Int. Cl. H04L 9/32; G06F 21/00

(52) U.S. Cl. 726/7; 713/183

(57) ABSTRACT

An authenticator may include graphical passwords. An authenticator may include a password image, which may include one or more clickable areas, and/or a key image, which may include click point data. An authenticator may include a mobile computing resource, a terminal computing resource and/or a challenger, which may be configured to communicate with each other. A mobile computing resource may be configured to receive and/or display a key image, such that click point data may be presented, determined, and/or input to a password image. A challenger may be configured to compare input click point data and a key image.

### CROSS REFERENCE TO RELATED APPLICATIONS

The present application claims the benefit of provisional application No. 61/145,230 to Stavrou et al., filed on Jan. 16, 2009, entitled “Universal Multi-Factor Authentication Using Graphical Passwords,” which is hereby incorporated by reference in its entirety.

### DESCRIPTION OF THE DRAWINGS

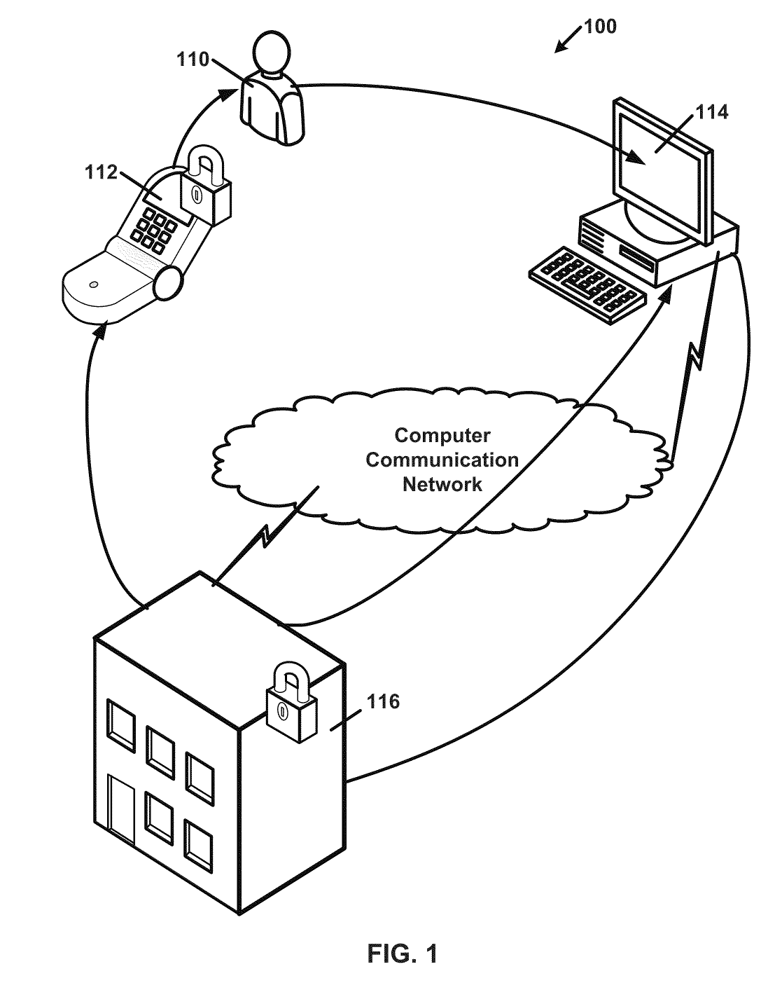

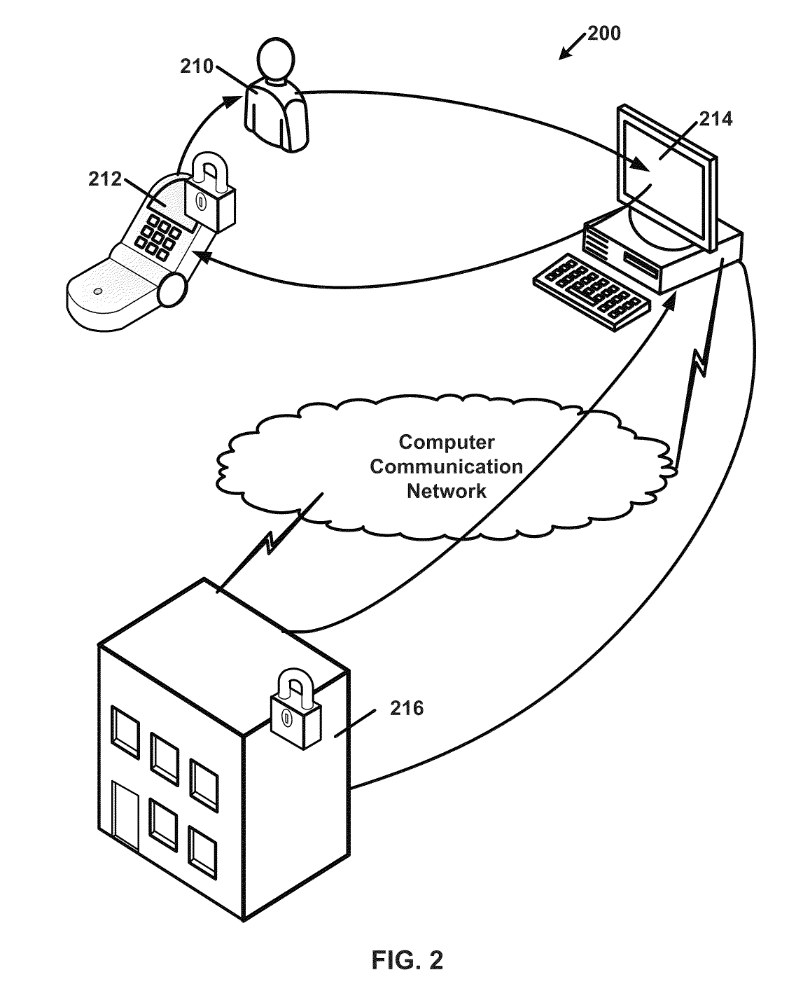

Example FIG. 1 illustrates an authenticator using a graphical password in accordance with embodiments.

Example FIG. 2 illustrates an authenticator using a graphical password in accordance with embodiments.

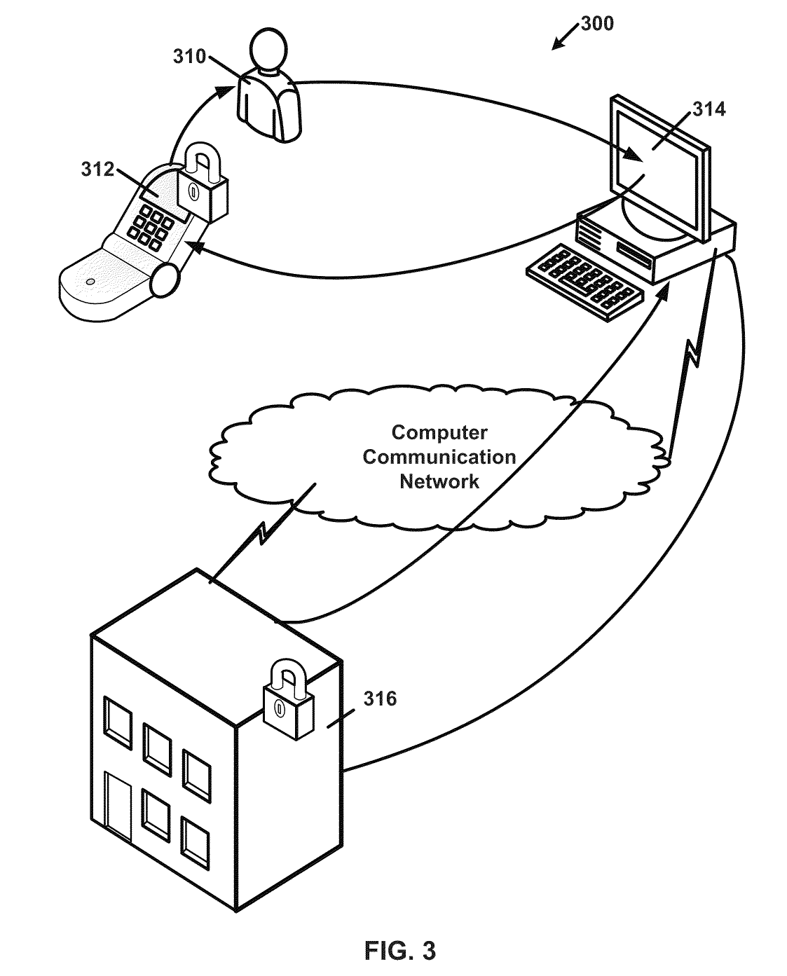

Example FIG. 3 illustrates an authenticator using a graphical password in accordance with embodiments.

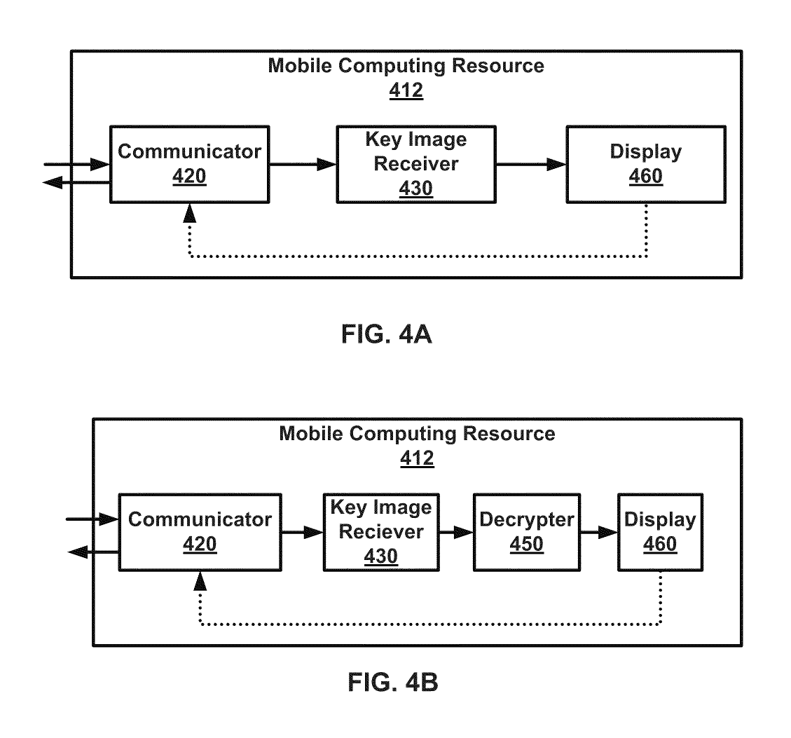

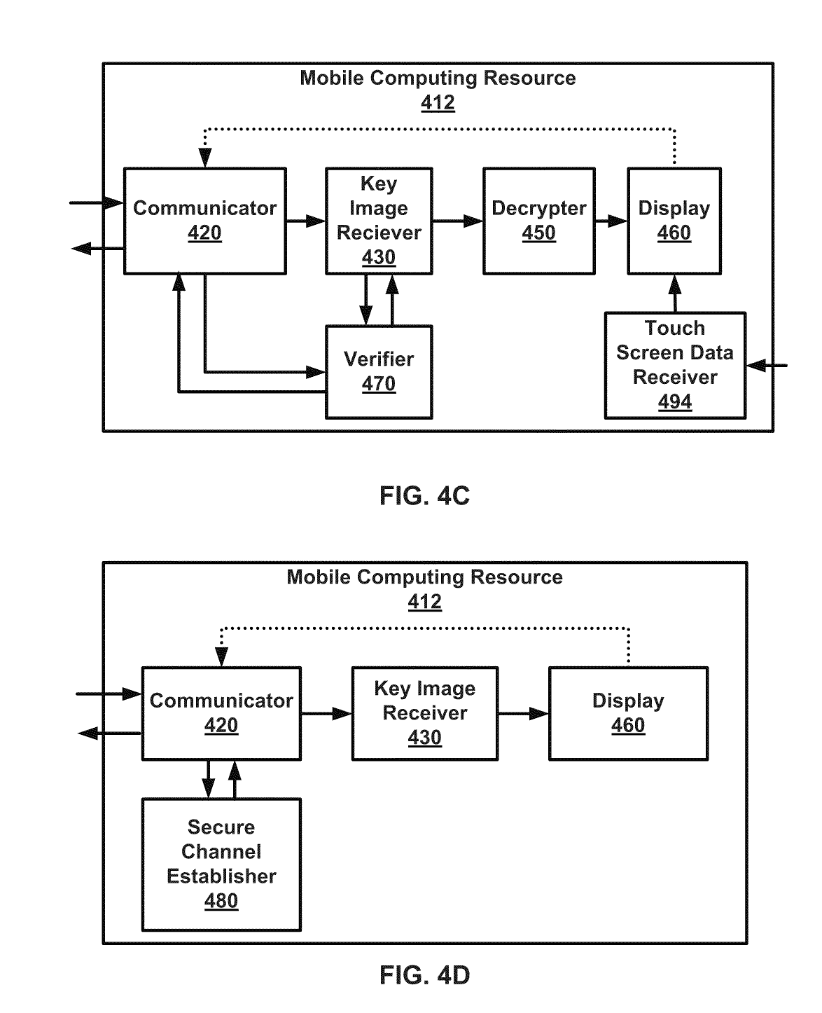

Example FIG. 4A to FIG. 4D illustrates an authenticator including a mobile computing resource in accordance with embodiments.

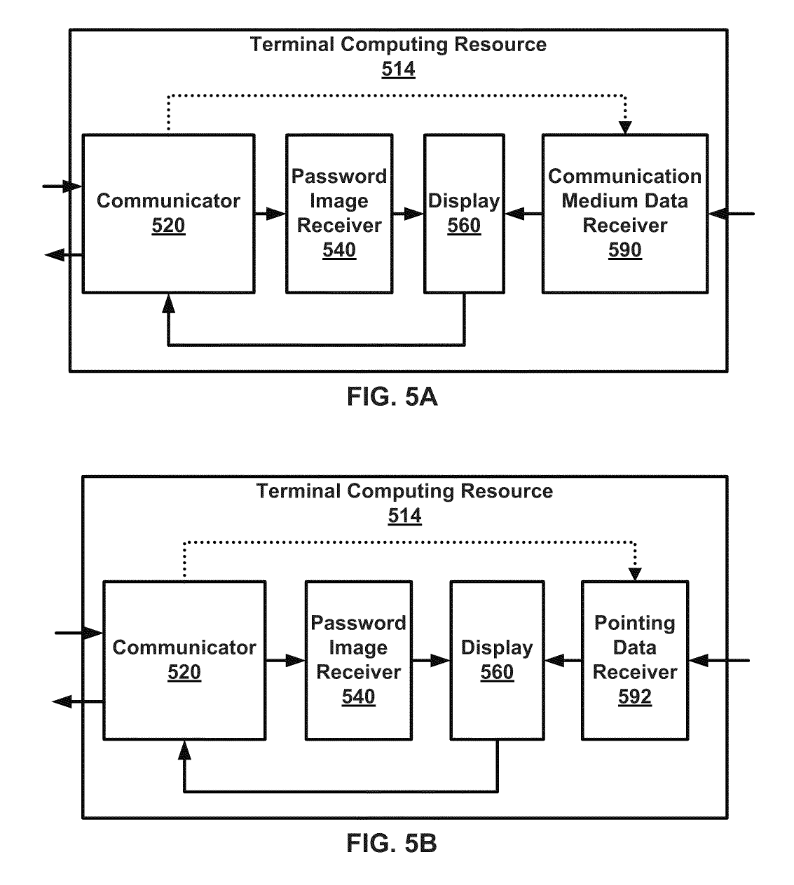

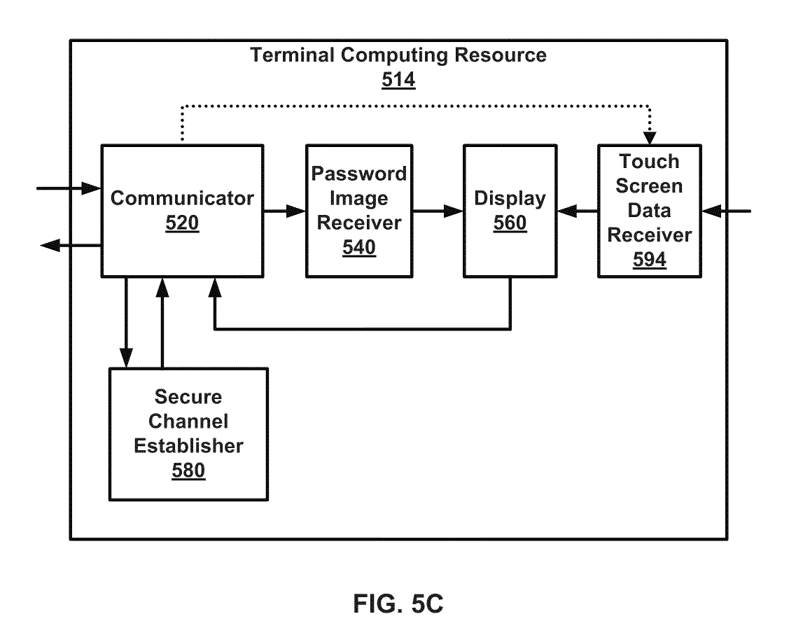

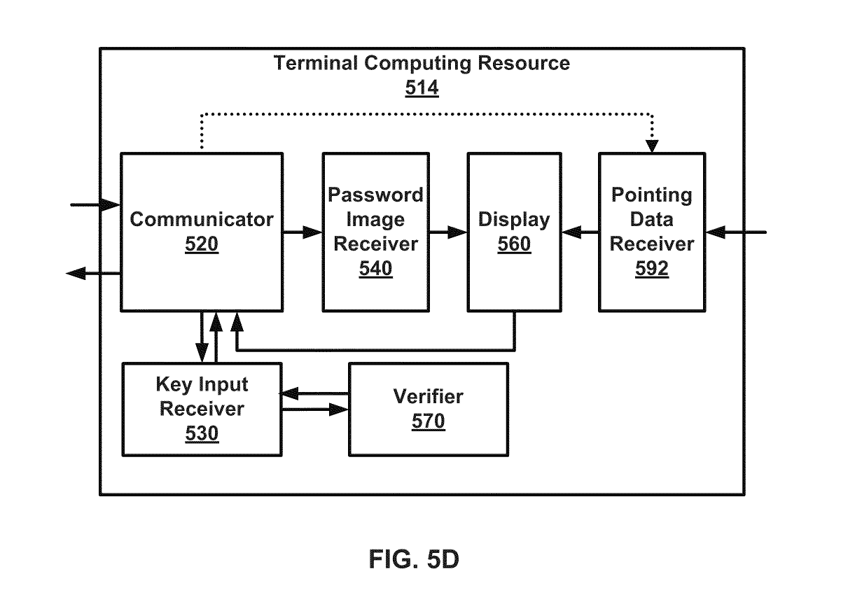

Example FIG. 5A to FIG. 5D illustrates an authenticator including a terminal computing resource in accordance with embodiments.

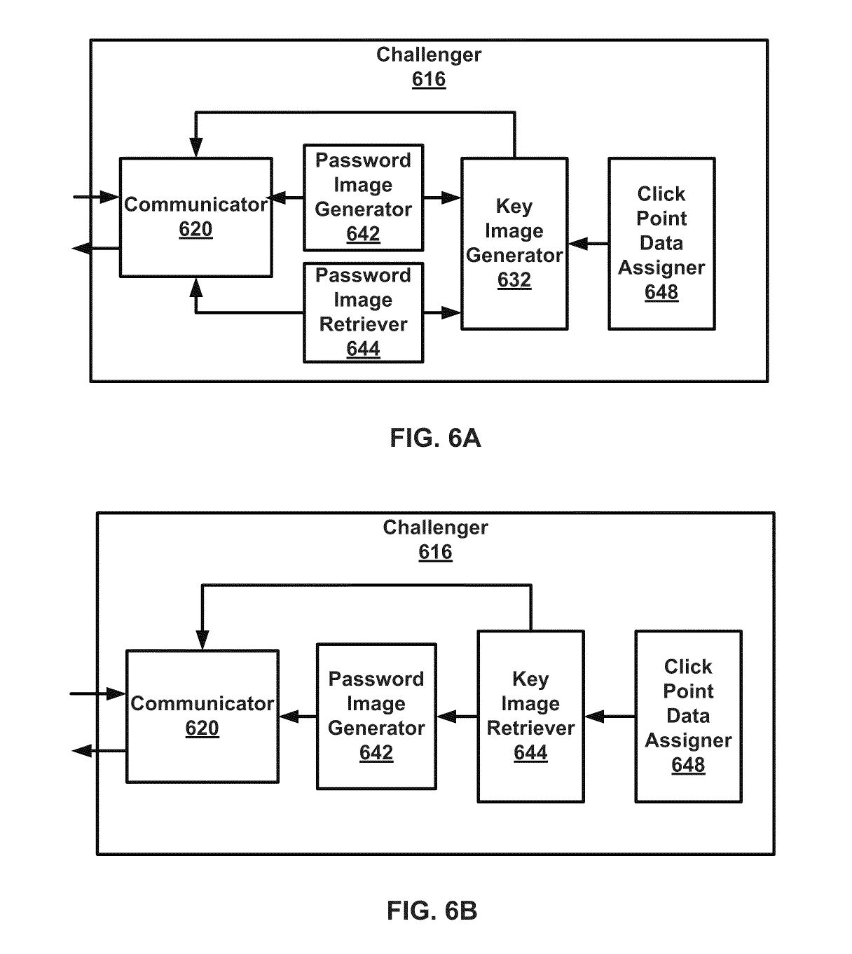

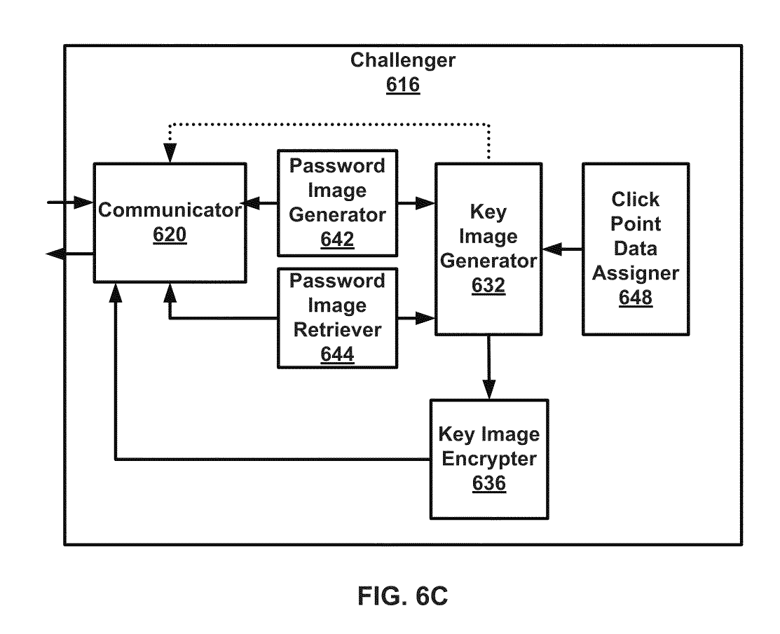

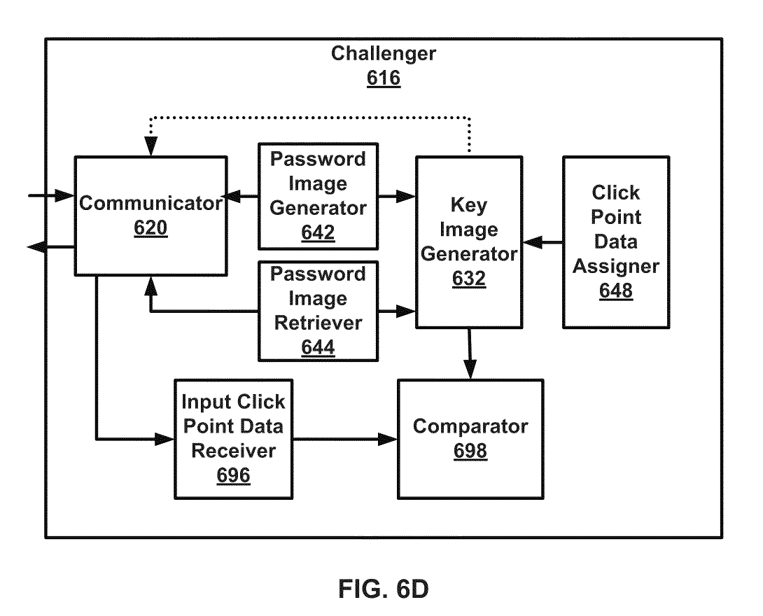

Example FIG. 6A to FIG. 6E illustrates an authenticator including a challenger in accordance with embodiments.

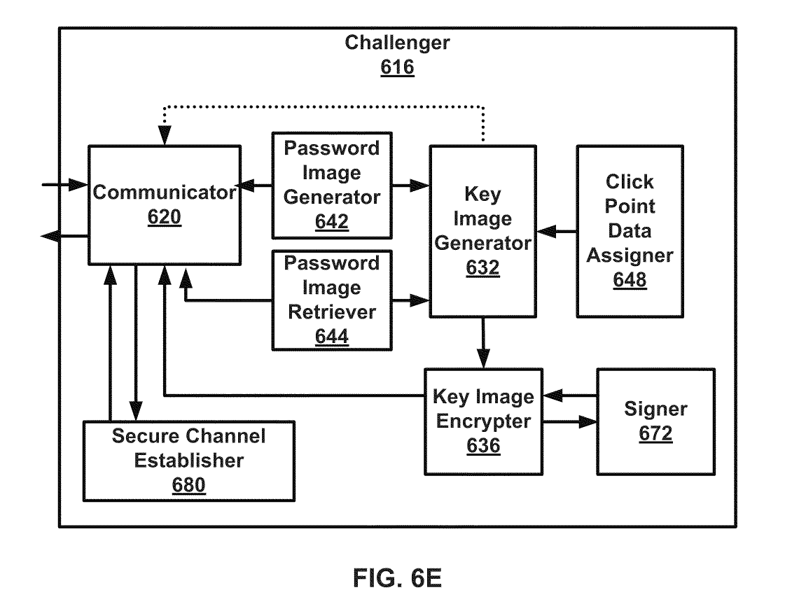

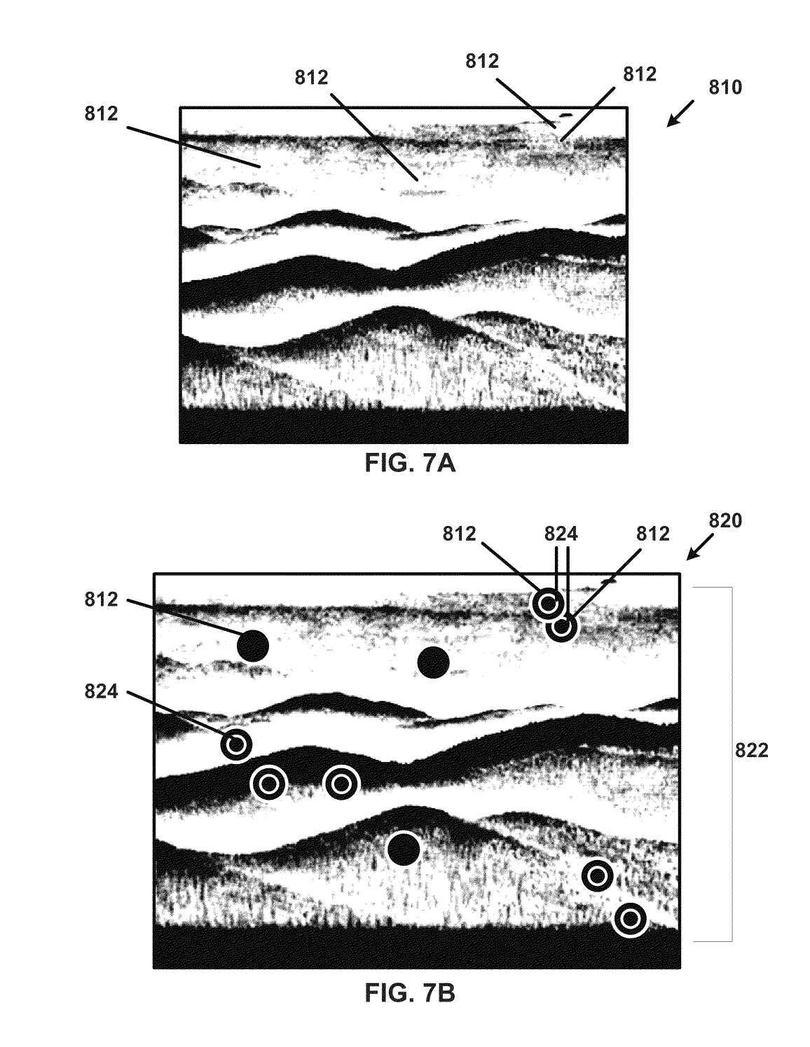

Example FIG. 7A and FIG. 7B illustrates a password image and a key image in accordance with embodiments.

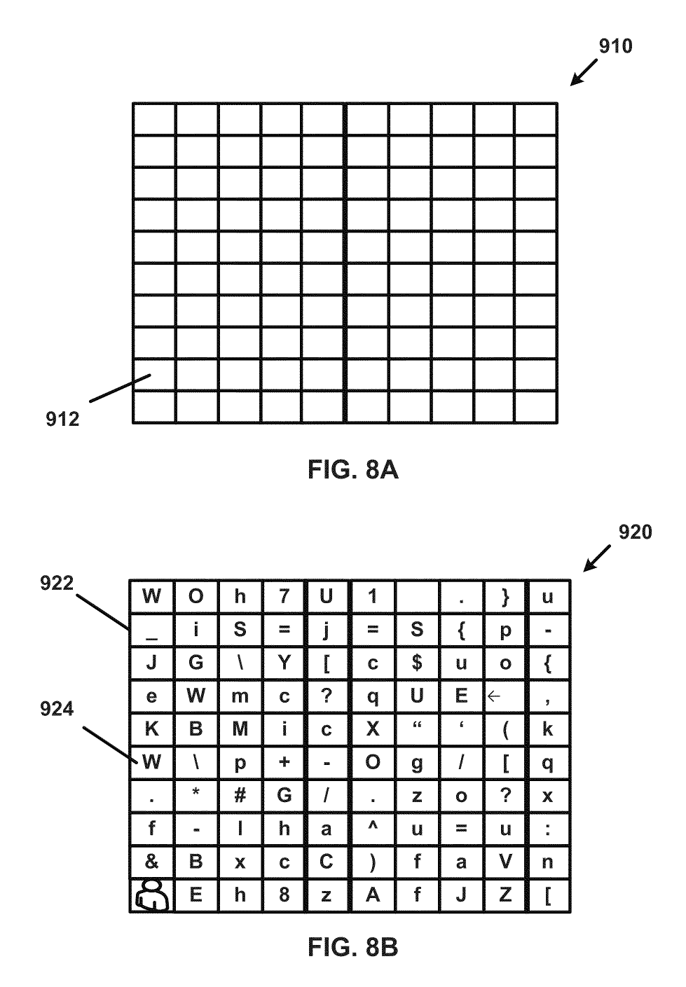

Example FIG. 8A and FIG. 8B illustrates a password image and a key image in accordance with embodiments.

### DESCRIPTION OF THE EMBODIMENTS

Embodiments relate to authentication. Some embodiments relate to an authenticator. Some embodiments relate to universal multi-factor authentication using graphical passwords.

Authentication may reference confirming the authenticity of a user's identity claim, for example a digital identity claim. Authentication mechanisms may include utilizing factors such as an object, for example an object a user may have, a secret, for example s a secret a user may know, and/or a unique identifier, for example a biometric identifier of a user.

Text-based authentication platforms may be vulnerable to attack as a result of relatively weak and/or easily determined user-selected passwords, malware, and/or keyboard sniffers. Attacks on text-based authentication platforms may include guessing, dictionary, key-logger, shoulder-surfing and/or social engineering attacks.

Graphical authentication platforms may minimize text-based system attacks. Graphical authentication may include using graphical objects, such as a graphical input, to confirm the authenticity of a user's identity claim. Graphical authentication may include entering a password by clicking on a set of images, specific pixels of an image, and/or drawing a pattern in a predefined and/or secret order. Recognition-based systems may have a series of images which are presented to a user such that authentication includes clicking correct images in a correct order. Recall-based systems may ask a user to reproduce information a user created and/or preselected during a registration process. However, such systems may be venerable to guessing, spyware, and/or shoulder-surfing attacks. Such systems may also be venerable to screen recording attacks and/or include hotspot vulnerabilities, which may relate to areas in an image which may be more likely to be selected by a user.

Multi-factor authentication platforms may minimize text-based system attacks. Multi-factor authentication may include using two or more factors as part of a user credential to confirm the authenticity of a user's identity claim. Factors that may be used in text-based platforms may include smart cards, USB tokens, handheld devices, and/or one-time password tokens. However, two-factor authentication platforms may present usability challenges. In Multi-factor authentication platforms, authentication may not be standardized, users may be required to remember a plurality of unique passwords, and/or users may be required to carry multiple physical items as a second authentication factor.

Embodiments relate to an authenticator. In embodiments, an authenticator may minimize attacks, including dictionary, guessing, spyware, shoulder-surfing, social engineering, and/or screen recording attacks, as well as hotspot vulnerabilities.

Referring to example FIG. 1, an authenticator is illustrated in accordance with embodiments. According to embodiments, authenticator 100 may include mobile computing resource 112 and/or terminal computing resource 114. In embodiments, mobile computing resource 112 and/or terminal computing resource 114 may communicate with challenger 116.

According to embodiments, authenticator 100 may authenticate user 110. According to embodiments, authentication may include providing mobile computing resource 112 and/or terminal computing resource 114 to user 110. In embodiments, mobile computing resource 112 and/or terminal computing resource 114 may communicate with challenger 116. In embodiments, resources 112, 114, 116 may be configured to communicate with each other. As illustrated in an aspect of embodiments in FIG. 1, mobile computing resource 112 and/or terminal computing resource 114 may be configured to directly communicate with challenger 116.

According to embodiments, authentication may include displaying a password image at terminal computing resource 114, which may be generated at challenger 116 and/or may include one or more clickable areas. In embodiments, a password image may be generated and/or sent from challenger 116 to terminal computing resource 114 through a computer communication network, for example through the Internet and/or an Intranet. In embodiments, a password image may be transmitted over any suitable public/and or private communication network, for example including a satellite and/or cellular communication network. As illustrated in an aspect of embodiments in FIG. 1, a password image may be sent from challenger 116 to terminal computing resource 114 over a computer communication network.

According to embodiments, authentication may include receiving a key image at mobile computing resource 112. In embodiments, a key image may be generated by challenger 116 and/or may include an encrypted copy of a password image which may include click point data. In embodiments, a key image may be sent from challenger 116 to mobile computing resource 112 over any suitable public/and or private communication network, for example a computer communication network. In embodiments, receiving a key image may include direct communication between mobile computing resource 112 and challenger116, which may include exchanging an electronic mail message, an instant message, a text message, a video message and/ or a picture message. As illustrated in an aspect of embodiments in FIG. 1, a key image may be sent from challenger 116 to mobile computing resource 110 directly over a cellular communication network.

According to embodiments, authentication may include processing a key image at mobile computing resource 112. In embodiments, processing a key image may include displaying a key image as received. In embodiments, a key image may be decrypted at mobile computing resource 112. In embodiments, click point data may be extracted and/or displayed at mobile computing resource 112. As illustrated in an aspect of embodiments in FIG. 1, click point data may be displayed using a LED display of a mobile computing device 112.

According to embodiments, authentication may include inputting click point data to one or more clickable areas. In embodiments, a user may input click point data to one or more clickable areas at terminal computing resource 114. In embodiments, inputting click point data to one or more clickable areas may include inputting click point data to a decrypted key image at mobile computing resource 112 and transferring input click point data from mobile computing resource 112 to terminal computing resource 114, for example using a communication medium between resources 112, 114. In embodiments, a communication medium may include wireless communication such as Bluetooth, WiFi, Firewire and /or cellular, and/or any other suitable communication medium, such as USB and/or Ethernet. As illustrated in an aspect of embodiments in FIG. 1, inputting click point data may include input click point data to one or more clickable areas at terminal computing resource 114 using a touch-screen.

According to embodiments, authentication may include comparing input click point data and a decrypted copy of a key image at challenger 116 to authenticate user 110. In embodiments, input click point data may be sent from terminal computing resource 114 to challenger 116 over any suitable public/and or private communication network. As illustrated in an aspect of embodiments in FIG. 1, input click point data may be sent from terminal computing resource 114 to challenger 116 over a wireless communication network.

Referring to example FIG. 2, an authenticator is illustrated in accordance with embodiments. According to embodiments, authenticator 200 may be configured to authenticate user 210. In embodiments, similar reference numerals may be used to represent similar elements. According to embodiments, mobile computing resource 212 may be configured to indirectly communicate with challenger 216. In embodiments, terminal computing resource 214 may be configured to directly communicate with challenger 216. In embodiments, a password image may be sent from challenger 216 to terminal computing resource 214 over any suitable private and/or public network, for example a computer communication network.

According to embodiments, authentication may include receiving a key image at mobile computing resource 212. In embodiments, a key image may be sent from challenger 216 to terminal computing resource 214 over any suitable public/and or private communication network. In embodiments, receiving a key image at mobile computing resource 212 may include medium assisted communication between mobile computing resource 212 and challenger 216. In embodiments, medium assisted communication may include a capturing device to capture a key image, for example a camera. As illustrated in an aspect of embodiments in FIG. 2, a camera of mobile computing device 212 may be used to capture a key image, for example sent to terminal computing resource 214.

Referring to example FIG. 3, an authenticator is illustrated in accordance with embodiments. According to embodiments, authenticator 300 may be configured to authenticate user 310. In embodiments, receiving a key image at mobile computing resource 312 may include medium assisted communication between mobile computing resource 312 and challenger 316. In embodiments, a communication medium may include wireless communication such as Bluetooth, WiFi, Firewire, and /or cellular, and/or any other suitable communication medium, including USB and/or Ethernet. As illustrated in an aspect of embodiments in FIG. 3, a communication medium such as Bluetooth may be used between mobile computing device 312 and terminal computing resource 314 to transfer a key image to mobile computing resource 312 from challenger 316.

According to embodiments, an authenticator may include a mobile computing resource. In embodiments, a mobile computing resource may reference a mobile computing device that may be equipped with a display. In embodiments, any suitable display configured to display one or more graphical objects may be employed, for example a LED display, an LCD display, a 2D and/or 3D projector display that may include feedback mechanisms. In embodiments, a mobile computing resource may store cryptographic keys and/or execute encryption-related calculations, for example one-way encryption and/or two-way encryption calculations. In embodiments, a mobile computing resource may include, for example, a cellular phone, a personal digital assistant, a notebook personal computer and/or a tablet personal computer.

Referring to example FIG. 4A to FIG. 4D, a mobile computing resource in accordance with embodiments is illustrated. According to embodiments, mobile computing resource 412 may include communicator 420, which may be configured to communicate with a terminal computing resource and/or a challenger. In embodiments, communicator 420 many include any suitable communication device, for example an antenna and/or a network interface card. In embodiments, communicator 420 may include any suitable computer implemented instruction, for example an instruction to implement TCP/IP. In embodiments, communicator 420 may be configured to form a communication link over any suitable medium, for example CDMA, GSM, WiFi, Firewire, Bluetooth and/or Ethernet.

According to embodiments, mobile computing resource 412 may include key image receiver 430. In embodiments, key image receiver 430 may be configured to receive a key image, for example from communicator 420. In embodiments, mobile computing resource 412 may include key image decrypter 450. In embodiments, key image decrypter 450 may be configured to decrypt an encrypted copy of a password image such that click point data may be extracted. In embodiments, any suitable asymmetrical and/or symmetrical encryption platform may be implemented, for example RSA.

According to embodiments, mobile computing resource 412 may include display 460. In embodiments, display 460 may be configured to display one or more graphical objects. In embodiments, display 460 may be configured to input data, for example using a touch-screen. In embodiments, mobile computing resource 412 may be configured to forward input data, for example input click point data, to a terminal computing resource and/or a challenger, for example through communicator 420.

According to embodiments, mobile computing resource 412 may include verifier 470, which may be configured to verify a signed key image and/or verify a site where authorization credentials may be submitted. In embodiments, mobile computing resource 412 may include secure channel establisher 480, which may be configured to establish a secure tunnel with a terminal computing resource and/or a challenger. In embodiments, secure channel establisher 480 may be configured to implement any suitable secure session, for example implementing IPSec, SSH, and/or SSL.

According to embodiments, an authenticator may include a terminal computing resource. In embodiments, a terminal computing resource may reference a computing device that may be equipped with a display and/or may be configured to input data. In embodiments, a terminal computing device may receive input data by any other suitable technology. In embodiments, a terminal computing resource may include a communication input device, which may be configured to receive input data through a communication medium. In embodiments, a terminal computing resource may include a pointing input device, for example a mouse. In embodiments, a terminal computing device may include a touch-screen.

Referring to example FIG. 5A to 5D, a terminal computing resource is illustrated in accordance with embodiments. According to embodiments, terminal computing resource 514 may include communicator 520, which may be configured to communicate with a mobile computing resource and/or a challenger. In embodiments, terminal computing resource 514 may include password image receiver 540, which may be configured to receive a password image. In embodiments, a terminal computing resource may include key image receiver 530, which may be configured to receive a key image.

According to embodiments, terminal computing resource 514 may include communication medium data receiver 590, pointing data receiver 592 and/or touch-screen data receiver 594, each of which may be configured to receive input data, for example input click point data. In embodiments, terminal computing resource may include display 560, which may be configured to display one or more graphical objects. In embodiments, terminal computing resource 514 may include verifier 570, which may be configured to verify a signed key. In embodiments, terminal computing resource 514 may include secure channel establisher 580, which may be configured to establish a secure session with a mobile computing resource and/or a challenger.

According to embodiments, an authenticator may include a challenger. According to embodiments, a challenger may reference a resource configured to present one or more authentication mechanisms to a user, such that a user may be required to successfully complete one or more presented mechanisms to access a resource. In embodiments, accessing a resource may include, for example inputting and/or outputting data, entering and/or leaving a physical and/or virtual location. In embodiments, a challenger may include a communications service provider, for example an online service provider. In embodiments, a challenger may include an authentication administrator, for example a public/and or private server, a predetermined computer executable instruction.

Referring to example FIG. 6A to FIG. 6E, a challenger is illustrated in accordance with embodiments. According to embodiments, challenger 616 may include communicator 620, which may be configured to communicate with a mobile computing resource and/or a terminal computing resource. In embodiments, challenger 616 may include password image generator 642 and/or password image retriever 644, which may be configured to generate a password image and/or retrieve a password image. In embodiments, challenger 616 may include key image generator 632 and/or key image retriever 634, which may be configured to generate a key image and/or retrieve a key image. In embodiments, challenger 616 may include a click point data assigner 648, which may be configured to assign generated and/or retrieved click point data to a password image. In embodiments, challenger 616 may include key image encrypter 636, which may be configured to encrypt a copy of a key image.

According to embodiments, challenger 616 may include input click point data receiver 696, which may be configured to receive input click point data from a mobile computing resource and/or a terminal computing resource. In embodiments, challenger 616 may include comparator 698, which may be configured to compare input click point data and a key image, which may be a decrypted copy of a password image including click point data. In embodiments, challenger 616 may include signer 672, which may be configured to sign a key image. In embodiments, challenger 616 may include secure channel establisher 680, which may be configured to establish a secure session with a terminal computing resource and/or a terminal computing resource.

According to embodiments, an authenticator may include one or more graphical passwords. Referring to example FIG. 7A to FIG. 7B, a password image and/or a key image is illustrated in accordance with embodiments. According to embodiments, an authenticator may include password image 810. In embodiments, password image 810 may include one or more clickable areas 812, which may be hidden and/or highlighted to a user. In embodiments, any suitable graphical object, for example an image of a landscape, an object, and/or an individual may represent password image 810. As illustrated an aspect of embodiments in FIG. 7A, password image 810 may be represented by a landscape.

According to embodiments, password image 810 may be in plain text and/or may be encrypted, for example when a password image may contain information related to click point data. In embodiments, information related to click point data may include one or more hints to a user to determine click point data. In embodiments, password image 810 may be randomly generated and/or preselected by a user. In embodiments, password image 810 may include an area substantially equal to or unequal to the area of a display.

According to embodiments, an authenticator may include key image 820. In embodiments, key image 820 may include an encrypted copy of password image 810 having click point data 822. In embodiments, key image 820 may be randomly generated and/or preselected by a user. In embodiments, key image 820 may include an area substantially equal to or less than the area of a display.

According to embodiments, click point data 822 may include one or more click points 824 associated with one or more clickable areas 812. In embodiments, the number of click points 824 may be equal and/or unequal to the number of clickable areas 812. In embodiments, click point data may be highlighted, for example in a decrypted key image, and/or may be a user-defined password, for example randomly distributed within a image. In embodiments, click point data 822 may include a click point location and/or a click point order. In embodiments, click point data 822 may be preselected and/or randomly generated. As illustrated an aspect of embodiments in FIG. 7B, click point data 822 may include highlighted click points 824 in their respective locations and/or order.

Referring to example FIG. 8A to FIG. 8B, a password image and/or a key image is illustrated in accordance with embodiments. According to embodiments, an authenticator may include password image 910. In embodiments, password image 910 may include one or more clickable areas 912, which may be hidden and/or highlighted to a user. In embodiments, any suitable graphical object, for example a matrix, may represent password image 910. As illustrated an aspect of embodiments in FIG. 8A, a ten-by-ten matrix may represent password image 910.

According to embodiments, password image 910 may be in plain text and/or may be encrypted, for example when a password image may contain information related to click point data. In embodiments, information related to click point data may include one or more hints to a user to determine click point data. In embodiments, password image 910 may be randomly generated and/or preselected by a user. In embodiments, password image 910 may include an area substantially equal to and/or unequal to the area of a display.

According to embodiments, an authenticator may include key image 920. In embodiments, key image 920 may include an encrypted copy of password image 910 having click point data 922. In embodiments, key image 920 may be randomly generated and/or preselected by a user. In embodiments, key image 920 may include an area substantially equal to and/or unequal to an area of a display.

According to embodiments, click point data 922 may include one or more click points 924 associated with one or more clickable areas 912. In embodiments, the number of click points 924 may be equal and/or unequal to the number of clickable areas 912. In embodiments, click point data may be highlighted, for example in a decrypted key image, and/or may be a user-defined password, for example randomly distributed within a matrix. In embodiments, click point data 922 may include a click point location and/or a click point order. In embodiments, click point data 922 may be preselected and/or randomly generated.

### Example Embodiment

According to embodiments, an authenticator may include a web-based system using .Net technology. In embodiments, one or more types of password images may be used. In embodiments, one or more random images including one or more random clickable areas may be used. In embodiments, one or more user selected images including one or more random clickable areas may be used. In embodiments, one or more grids including one or more clickable squares may be used.

According to embodiments, an authenticator may include one or more clickable areas, which may be implemented using deployable browser-independent server-side HTML Image Maps including one or more hot spots. In embodiments, a hop spot may be shaped, for example circular and/or rectangular hot spots. In embodiments, one or more clickable areas may be associated with a random code that may be meaningful only to a challenger, for example an authentication server. In embodiments, a random code may be forwarded to an authentication server when a clickable area may be clicked.

According to embodiments, an authenticator may include one or more communication types. In embodiments, for example, a mobile computing resource, which may include a cellular phone, and/or a terminal computing resource, which may include a desktop computer, may be configured to directly communicate with a challenger. In embodiments, a key image may be displayed at a mobile computing resource that may indicate click point data to a user. In embodiments, click point data, for example click point location and/or click point order, may be input to a terminal computing resource using a mouse and/or forwarded to a challenger, which may compare input click point data with a decrypted copy of a key image.

### Further Example Embodiments

According to embodiments, an authenticator may be applicable to any platform where there may be a need to input and/or output sensitive and/or private data. In embodiments, for example, a user may be authenticated to securely transmit social security information. In embodiments, an authenticator may be applicable to any platform where there may be a need to enter and/or leave a sensitive and/or private physical and/or virtual location. In embodiments, for example, a user may be authenticated to enter a private physical location such a network data center, a public physical location such as a sporting events stadium, and/or a virtual location such as an online banking system.

According to embodiments, an authenticator may include a mobile computing resource, a terminal computing resource and/or a challenger, which may be configured to communicate with each other. In embodiments, elements of an authenticator may be swapped, supplemented, added and/ deleted among resources in any combination suitable to authenticate a user in accordance with embodiments. In embodiments, for example, a mobile computing resource may include a pointing data receiver that may be used with notebook personal computer. In embodiments, a mobile computing resource, a terminal computing resource and/or a challenger may be swapped, supplemented, added and/ deleted in any combination suitable to authenticate a user in accordance with embodiments. In embodiments, for example, multiple challengers may be used, for example based on any predetermined criteria such as bandwidth, type of service, user, and/or authentication request.

According to embodiments, a mobile computing resource may be configured to receive and/or display a key image, such that click point data may be presented, determined, and/or input to a password image. In embodiments, a mobile computing resource may operate as a password decoder and/or as a second factor of authentication. In embodiments, a mobile computing resource may not be assumed to be trusted. In embodiments, secure authentication of a user may be accomplished substantially without requiring a user to memorize different passwords and/or carry multiple physical items. In embodiments, there may be substantially no need for familiarization and/or relatively long set up processes, such as password setup processes. In embodiments, authentication may be provided through an unsecured terminal, for example a public desktop computer.

According to embodiments, a challenger may be configured to compare input click point data and a key image. In embodiments, a challenger may decrypt an encrypted copy of the key image to use in a comparison, and/or may combine the password image with the click point data used to implement in a comparison. In embodiments, a challenger may compare input click point data and a key image. In embodiments, a password image and/or a key may be sent to a mobile computing resource and input click point data may be sent to a challenger.

According to embodiments, an authenticator may include graphical passwords. In embodiments, an authenticator may include a password image and/or a key image. In embodiments, a user may select their images, for example providing images. In embodiments, machine-generated images may be used. In embodiments, random images including random clickable areas may be used, which may be randomly selected images and/or randomly machine-generated images. In embodiments, for example, a user may select images including random clickable areas. In embodiments, a grid of clickable areas may be used. In embodiments, a user may select a pin and/or a secret that may be incorporated in a graphical password. In embodiments, a key image may change for each authentication attempt while, for example, a password image may or may not change.

In embodiments, a password image may include one or more clickable areas. In embodiments, a key image may include click point data, which may have one or more click point locations and/or a click point order. In embodiments, a click point location may include location of an image in a particular area of a display, for example in a particular quadrant. In embodiments, an object may represent a password image and/or a key image, for example a word having letters and/or parts thereof as click point data.

According to embodiments, click point data may be marked and/or unmarked. In embodiments, click point data may be determined by a user from a hint and/or from a secret, such as a PIN and/or instruction. In embodiments, a hint and/or secret may include selecting a predetermined area of an image, for example selecting eyes, a predetermined order, for example selecting eyes first and hair second, and/or any other information, for example a predetermined image size.

According to embodiments, click point data may be randomly used. In embodiments, for example, random click points may be used. In embodiments, it may be relatively computationally more difficult to perform an attack. In embodiments, a number of unique clickable areas in a password image and/or a number of click points may define the combinatorial complexity of an authentication scheme. In embodiments, a size of a key space may grow relative to a number of clicks and/or a number of clickable areas. In embodiments, an image may include cc clickable areas and/or p click points, such that there may exist α^{P} possible valid password combinations. In embodiments, a probability of guessing a password may be 1/α^{P}.

According to embodiments, for example if there are 32 areas and a password length is 3 clicks, a total number of potential combinations may be represented by α^{P}=32⁶=2³⁰≈10¹⁰ and conversely a probability of success may be approximately 1/10¹⁰. In embodiments, 64 areas and 8 password clicks may produce approximately 2.8×10¹⁵ combinations.

According to embodiments, a user-defined PIN and/or password may be used, which may be incorporated into a key image. In embodiments, for example, with 94 characters valid for passwords, a 10 by 10 matrix may be used to provide a sufficient authentication platform. In embodiments, a user may be notified of an attempt to authenticate. In embodiments, notification may include, for example, an email, text, picture, and/or video message. In embodiments, notification may originate from a challenger.

The foregoing description of embodiments have been presented for purposes of illustration and description. They are not intended to be exhaustive or be limiting to the precise forms disclosed, and obviously many modifications and variations are possible in light of the above teaching. The illustrated embodiments were chosen and described in order to best explain the principles of the claimed invention and its practical application to thereby enable others skilled in the art to best utilize it in various embodiments and with various modifications as are suited to the particular use contemplated without departing from the spirit and scope of the claimed invention. In fact, after reading the above description, it will be apparent to one skilled in the relevant art(s) how to implement the claimed invention in alternative embodiments. Thus, the claimed invention should not be limited by any of the above described example embodiments. For example, embodiments may include any suitable graphical object, such as a word having letters and/or portions thereof as click point data. Embodiments may include inputting, outputting and/or accessing any secure and/or public space such that data may be collected for any purpose, including statistical data on use of resources and the like.

In addition, it should be understood that any figures, examples, etc., which highlight the functionality and advantages of embodiments are presented for example purposes only. The architecture of the disclosed is sufficiently flexible and configurable, such that it may be utilized in ways other than that shown. For example, the steps listed in any flowchart may be reordered or only optionally used in some embodiments.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the claimed invention of the application. The Abstract is not intended to be limiting as to the scope of the claimed invention in any way.

Furthermore, it is the applicants' intent that only claims that include the express language “means for” or “step for” be interpreted under 35 U.S.C. §112, paragraph 6. Claims that do not expressly include the phrase “means for” or “step for” are not to be interpreted under 35 U.S.C. §112, paragraph 6.

A portion of the claimed invention of this patent document contains material which is subject to copyright protection. The copyright owner has no objection to the facsimile reproduction by anyone of the patent document or the patent invention, as it appears in the Patent and Trademark Office patent file or records, but otherwise reserves all copyright rights whatsoever.

What is claimed is:

1. An authentication process comprising:
a. providing a mobile computing resource and a terminal computing resource, at least one of the mobile computing resource and the terminal computing resource configured to communicate with a challenger;
b. displaying a password image generated by the challenger at the terminal computing resource, the password image including at least one clickable area;
c. receiving a key image at the mobile computing resource, the key image including an encrypted copy of the password image having click point data encrypted by the challenger;
d. decrypting the key image at the mobile computing resource to display the click point data;
e. inputting the click point data to at least one of the at least one clickable area at the terminal computing resource; and
f. comparing the input click point data and a decrypted copy of the key image at the challenger to authenticate the user.

2. The authentication process of claim 1, wherein at least one of:
a. the mobile computing resource comprises at least one of:
i. a cellular phone;
ii. a personal digital assistant;
iii. a notebook personal computer; and
iv. a tablet personal computer.
b. the terminal computing resource comprises at least one of:
i. a communication input device;
ii. a pointing input device; and
iii. a touch-screen.
c. the challenger comprises at least one of:
i. a communications service provider; and
ii. an authentication administrator.

3. The authentication process of claim 1, wherein the click point data comprises at least one click point associated with the at least one of the clickable area.

4. The authentication process of claim 3, wherein a plurality of click points are fewer than a plurality of clickable areas.

5. The authentication process of claim 1, wherein the click point data is at least one of:
a. highlighted in the decrypted key image at the mobile computing resource; and
b. determined by the user using the decrypted key image at the mobile computing resource based on predetermined data.

6. The authentication process of claim 1, wherein the click point data comprises at least one of:
a. a click point location; and
b. a click point order.

7. The authentication process of claim 1, wherein receiving the key image comprises at least one of:
a. direct communication between the mobile computing resource and the challenger; and
b. medium assisted communication between the mobile computing resource and the challenger.

8. The authentication process of claim 7, wherein the direct communication comprises at least one of:
a. an electronic mail message;
b. an instant message;
c. a text message;
d. a video message; and
e. a picture message.

9. The authentication process of claim 7, wherein the medium assisted communication comprises at least one of:
a. a mobile computing resource camera to capture the key image; and
b. a communication medium to transfer the key image from the terminal computing resource to the mobile computing resource.

10. The authentication process of claim 1, comprising establishing a secure session between the mobile computing resource and at least one of:
a. the terminal computing resource; and
b. the challenger.

11. The authentication process of claim 1, comprising notifying the user of an attempt to authenticate.

12. The authentication process of claim 1, comprising:
a. signing the key image at the challenger; and
b. verifying the signed key image at the mobile computing resource.

13. The authentication process of claim 1, wherein inputting the click point data to the at least one clickable area comprises:
a. inputting the click point data to the decrypted key image at the mobile computing resource; and
b. transferring the input click point data to the terminal computing resource.

14. The authentication process of claim 1, comprising at least one of:
a. the user preselecting click the point data; and
b. the challenger assigning the click point data.

15. The authentication process of claim 1, wherein at least one of the password image and the key image comprises at least one of an assigned area and a predetermined area of at least one the display of the mobile computing resource and a display of the terminal computing resource.

16. An authenticator comprising:
a. a mobile computing resource and a terminal computing resource, at least one of the mobile computing resource and the terminal computing resource configured to communicate with a challenger, wherein:
i. the terminal computing resource is configured to display a password image generated by the challenger, the password image including at least one clickable area;
ii. the mobile computing resource is configured to receive a key image, the key image including an encrypted copy of the password image having click point data encrypted by the challenger, and is configured to decrypt the key image;
iii. the terminal computing resource is configured to receive input click point data to at least one of the at least one clickable area of the password image; and
iv. the challenger is configured to compare the input click point data and a decrypted copy of the key image to authenticate the user.

17. The authenticator of claim 16, wherein at least one of:
a. the mobile computing resource comprises at least one of:
i. a cellular phone;
ii. a personal digital assistant;
iii. a notebook personal computer; and
iv. a tablet personal computer.
b. the terminal computing resource comprises at least one of:
i. a communication input device;
ii. a pointing input device; and
iii. a touch-screen.
c. the challenger comprises at least one of:
i. a communications service provider; and
ii. an authentication administrator.

18. The authenticator of claim 16, wherein at least one of the mobile computing resource and the terminal computing resource is configured to receive at least one of the password image and the key image by at least one of:
a. direct communication; and
b. medium assisted communication.

19. The authenticator of claim 16, wherein the authenticator is configured to enable at least one of:
a. the user to select the click point data; and
b. the challenger to assign the click point data.

20. An authenticator comprising:
a. a communicator configured to communicate with at least one of a terminal computing resource and a challenger;
b. a key image receiver configured to receive a key image, the key image including an encrypted copy of a password image having click point data encrypted by the challenger;
c. a key image decrypter configured to decrypt the encrypted copy of the password image to extract click point data; and
d. a display configured to present click point data to a user.
